(19) United States
(12) Patent Application Publication
(10) Pub. No.: US 2015/0252987 A1
(43) Pub. Date: Sep. 10, 2015

(54) Light Device

(71) Applicant: Lawrence C. Gaston, Camden, AL (US)

(72) Inventor: Lawrence C. Gaston, Camden, AL (US)

(21) Appl. No.: 14/196,464

(22) Filed: Mar. 4, 2014

(51) Int. Cl. F21V 21/00

(52) U.S. Cl. CPC F21V 21/00

(57) ABSTRACT

A light device lights areas such as camps and inside recreational vehicles. The device includes a housing, which may be constructed from a re-purposed 5 gallon bucket, having a bottom wall and a perimeter wall defining an interior space. A base extends through an aperture in the perimeter wall. A socket extends into the base and is positioned in the interior space of the housing. A light is electrically coupled to the socket. A plug is coupled to and extends from the base. The plug is electrically coupled to the socket wherein the socket is configured for delivering electrical current to the light when the plug is electrically coupled to an electrical outlet.

### BACKGROUND OF THE DISCLOSURE

1. Field of the Disclosure

The disclosure relates to light devices and more particularly pertains to a new light device for lighting areas such as camps and inside recreational vehicles.

2 Summary of the Disclosure

An embodiment of the disclosure meets the needs presented above by generally comprising a housing having a bottom wall and a perimeter wall defining an interior space. A base extends through an aperture in the perimeter wall. A socket extends into the base and is positioned in the interior space of the housing. A light is electrically coupled to the socket. A plug is coupled to and extends from the base. The plug is electrically coupled to the socket wherein the socket is configured for delivering electrical current to the light when the plug is electrically coupled to an electrical outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a light device according to an embodiment of the disclosure.

FIG. 2 is a top back perspective view of an embodiment of the disclosure.

FIG. 3 is a top view of an embodiment of the disclosure without a lid.

FIG. 4 is a cross-sectional view of an embodiment of the disclosure taken along line 4-4 of FIG. 3.

### DESCRIPTION OF THE PREFERRED EMBODIMENT

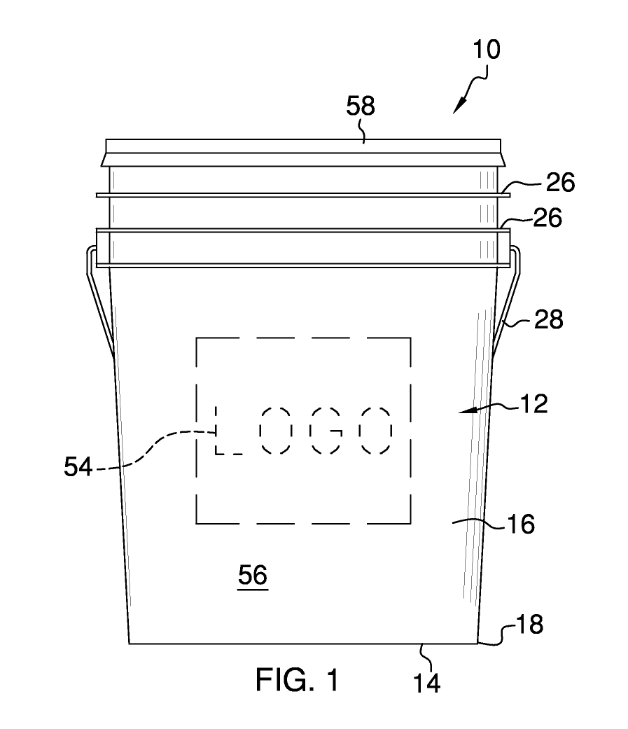

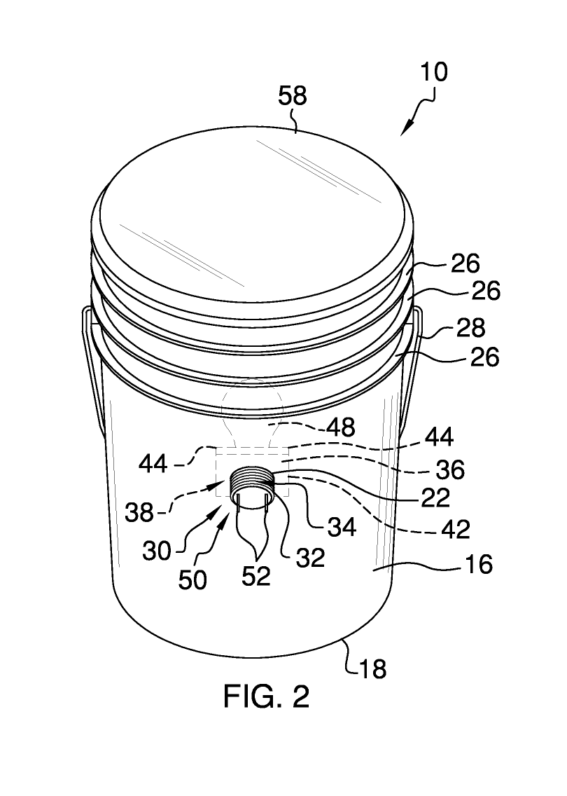

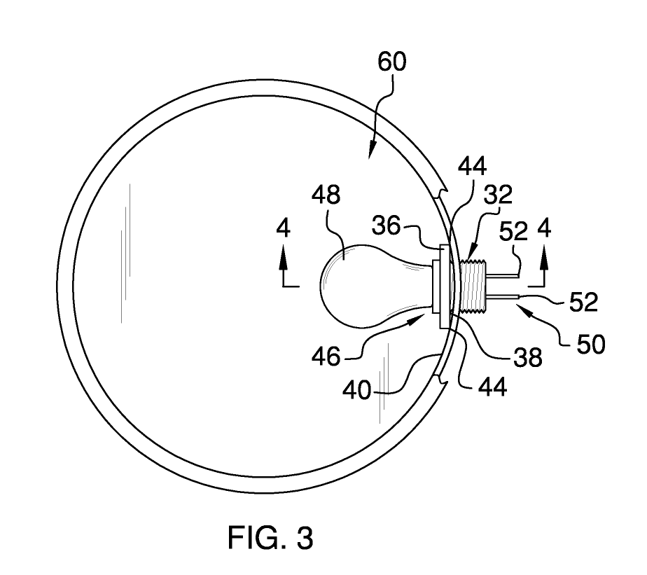

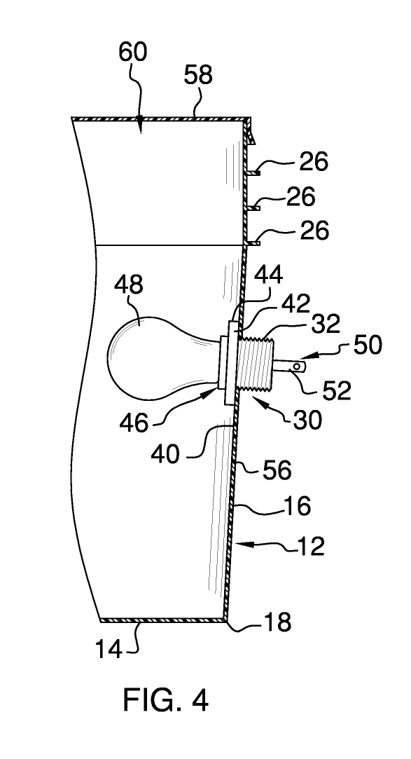

With reference now to the drawings, and in particular to FIGS. 1 through 4 thereof, a new light device embodying the principles and concepts of an embodiment of the disclosure and generally designated by the reference numeral 10 will be described.

As best illustrated in FIGS. 1 through 4, the light device 10 generally comprises a housing 12 having a bottom wall 14 and a perimeter wall 16 coupled to and extending upwardly from a perimeter edge 18 of the bottom wall 14 defining an interior space 20. The perimeter wall 14 has an aperture 22 extending therethrough. The housing 12 may comprise a translucent material 24 such as plastic, resin or the like. The device 10 typically incorporates re-use of a conventional five gallon plastic type bucket by converting the bucket into the housing 12. Thus, the housing 12 may have additional structural components such as ribs 26, a handle 28, and the like.

A base 30 extends through the aperture 22 in the perimeter wall 14. The base 30 has a cylindrical section 32 extending through the aperture 22. An outer surface 34 of the cylindrical section 32 is threaded. The cylindrical section 32 is threadedly coupled to the perimeter wall 14. The base 30 further has a planar section 36. The cylindrical section 32 extends transversely from the planar section 36. The planar section 36 defines a lip 38 at a junction of the cylindrical section 32 and the planar section 36 wherein the planar section 36 is positionable to abut an interior surface 40 of the perimeter wall 14 of the housing 12. A peripheral edge 42 of the planar section 36 has a plurality of corners 44 wherein the planar section 36 is geometrically shaped, such as being a square, and the corners 44 engage the interior surface 40 of the perimeter wall 14 of the housing 12 when the cylindrical section 32 is fully inserted through the aperture 22.

A socket 46 extends into the base 30. The socket 46 is positioned in the interior space of the housing 12 and configured to receive a conventional threaded portion of a light 48. The light 48 is electrically coupled to the socket 46 when the light 48 is fully inserted into the socket 46. A plug 50, comprising a pair of spaced prongs 52 configured for coupling to a conventional electrical outlet, is coupled to and extends from the base 30. The plug 50 is electrically coupled to the socket 46 wherein the socket 46 is configured for delivering electrical current to the light 48 when the plug 50 is electrically coupled to the electrical outlet.

Indicia 54, such as a company logo or sports logo, may be positioned on an outer surface 56 of the perimeter wall 14 of the housing 12. The indicia 54 may be residual from the original bucket or new indicia may be put onto the outer surface 56. A lid 58, which may be the original bucket lid, is removably coupled to the perimeter wall 14 wherein the lid 58 covers an opening 60 into the interior space 18. The lid 58 may also be translucent or opaque.

In use, a five gallon bucket is re-purposed into the housing 12. The base 30 is coupled to the housing 12 exposing the plug 50 extending from the housing 12 and allowing the plug 50 to be electrically coupled to an electrical source such as an extension cord. Thus, the housing 12 may be positioned as desired with the translucent perimeter wall 14 providing light to the surrounding area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light device comprising:
a housing having a bottom wall and a perimeter wall coupled to and extending upwardly from a perimeter edge of said bottom wall defining an interior space, said perimeter wall having an aperture extending therethrough;
a base extending through said aperture in said perimeter wall;
a socket extending into said base, said socket being positioned in said interior space of said housing;
a light, said light being electrically coupled to said socket; and
a plug coupled to and extending from said base, said plug being electrically coupled to said socket wherein said socket is configured for delivering electrical current to said light when said plug is electrically coupled to an outlet.

2. The device of claim 1, further comprising said base having a cylindrical section extending through said aperture.

3. The device of claim 2, further comprising said an outer surface of said cylindrical section being threaded, said cylindrical section being threadedly coupled to said perimeter wall.

4. The device of claim 3, further comprising said base having a planar section, said cylindrical section extending transversely from said planar section, said planar section defining a lip at a junction of said cylindrical section and said planar section wherein said planar section is positionable to abut an interior surface of said perimeter wall of said housing.

5. The device of claim 4, further comprising a peripheral edge of said planar section having a plurality of corners wherein said corners engage said interior surface of said perimeter wall of said housing when said cylindrical section is fully inserted through said aperture.

6. The device of claim 1, further comprising said housing comprising a translucent material.

7. The device of claim 1, further comprising indicia positioned on an outer surface of said perimeter wall of said housing.

8. The device of claim 1, further comprising a lid, said lid being removably coupled to said perimeter wall wherein said lid covers an opening into said interior space.

9. A light device comprising:
a housing having a bottom wall and a perimeter wall coupled to and extending upwardly from a perimeter edge of said bottom wall defining an interior space, said perimeter wall having an aperture extending therethrough, said housing comprising a translucent material;
a base extending through said aperture in said perimeter wall, said base having a cylindrical section extending through said aperture, an outer surface of said cylindrical section being threaded, said cylindrical section being threadedly coupled to said perimeter wall, said base having a planar section, said cylindrical section extending transversely from said planar section, said planar section defining a lip at a junction of said cylindrical section and said planar section wherein said planar section is positionable to abut an interior surface of said perimeter wall of said housing, a peripheral edge of said planar section having a plurality of corners wherein said corners engage said interior surface of said perimeter wall of said housing when said cylindrical section is fully inserted through said aperture;
a socket extending into said base, said socket being positioned in said interior space of said housing;
a light, said light being electrically coupled to said socket; and
a plug coupled to and extending from said base, said plug being electrically coupled to said socket wherein said socket is configured for delivering electrical current to said light when said plug is electrically coupled to an outlet;
indicia positioned on an outer surface of said perimeter wall of said housing; and
a lid, said lid being removably coupled to said perimeter wall wherein said lid covers an opening into said interior space.
